(19) United States
(12) Patent Application Publication
(10) Pub. No.: US 2026/0318594 A1
(43) Pub. Date: Oct. 15, 2026

(54) COMPACT CRYOGENIC CAPTURE SYSTEM AND METHOD

(71) Applicant: INDUSTRIAL CLIMATE SOLUTIONS INC., Calgary (CA)

(72) Inventors: Jahan Ahmadi, Calgary (CA); Adam Karcz, Calgary (CA)

(21) Appl. No.: 19/179,347

(22) Filed: Apr. 15, 2025

(51) Int. Cl. F25J 3/06

(52) U.S. Cl. CPC F25J 3/067; F25J 2205/24

(57) ABSTRACT

A system for separating and/or absorbing a component from a process fluid includes a mixing module configured to receive the process fluid at a first temperature and combine the process fluid with a cooling fluid to produce a fluid mixture having a second temperature that is less than or equal to the first temperature, where the process fluid includes the component. The system also includes a housing, a passageway disposed in the housing, the passageway configured to receive the fluid mixture, and a cooling module configured to inject a refrigerant into the housing to cool the fluid mixture to a third temperature and cause the component to change to a solid phase.

### BACKGROUND

In various industries, including the resource recovery and fluid sequestration industries, capture of various byproducts and/or generated gases may be necessary or desirable. For example, many subterranean operations for producing hydrocarbons include systems for capturing environmentally threatening gasses such as CO₂ from exhaust streams. Capture technologies may be used for other chemicals and/or processes, including, without limitation: natural gas production, sweetening, and the like.

Additionally, it may be desirable to remove a component, e.g., carbon dioxide, from atmospheric air. Various carbon capture technologies are available for capture and removal of carbon dioxide. Improvements to systems for capturing a component from flue gases, atmospheric air and other fluids is desirable.

### SUMMARY

An embodiment of a system for separating and/or absorbing a component from a process fluid that includes a mixing module configured to receive the process fluid at a first temperature and combine the process fluid with a cooling fluid to produce a fluid mixture having a second temperature that is less than or equal to the first temperature, where the process fluid includes the component. The system also includes a housing, a passageway disposed in the housing, the passageway configured to receive the fluid mixture, and a cooling module configured to inject a refrigerant into the housing to cool the fluid mixture to a third temperature and cause the component to change to a solid phase and separate from the fluid mixture.

An embodiment of a method for separating and/or absorbing a component from a process fluid, wherein the method includes receiving the process fluid that includes the component, the process fluid having a first temperature, and directing the process fluid to a mixing module and combining the process fluid with a cooling fluid to produce a fluid mixture having a second temperature that is less than or equal to the first temperature. The method also includes flowing the fluid mixture into a passageway disposed in a housing of a heat exchanger, and circulating a refrigerant in a space between the housing and the passageway, the refrigerant causing the fluid mixture to cool to a third temperature and cause the component to change to a solid phase and separate from the fluid mixture.

### BRIEF DESCRIPTION OF THE DRAWINGS

The following descriptions should not be considered limiting in any way. With reference to the accompanying drawings, like elements are numbered alike:

FIG. 1 shows a simplified schematic diagram of a separation and/or absorption system according to one or more embodiments;

FIG. 2 shows a simplified schematic diagram of a separation and/or absorption system according to one or more embodiments;

FIG. 3 shows a heat exchanger or absorption column assembly according to one or more embodiments;

FIG. 4 shows a cross-sectional view of a mixing unit structure according to one or more embodiments;

FIG. 5 shows a cross-sectional view of a downstream collector structure according to one or more embodiments; and

FIG. 6 shows a cross-sectional view of an absorption column assembly according to one or more embodiments;

FIG. 7 shows a cross-sectional view of an absorption column assembly according to one or more embodiments;

FIG. 8 shows an absorption column module according to one or more embodiments;

FIG. 9 shows a cross-sectional view of the absorption column module of FIG. 8; and

FIG. 10 shows a perspective view of a corrugated screen according to one or more embodiments.

### DETAILED DESCRIPTION

A detailed description of one or more embodiments of the disclosed apparatus and method are presented herein by way of exemplification and not limitation with reference to the Figures.

Systems, devices and methods are provided for thermal control of a process fluid and/or separation of components in a process fluid. An embodiment of a separation and/or absorption system (which may be configured as or include a heat exchanger) is configured to receive the process fluid and flow the process fluid through one or more passageways to cool the process fluid to a desired temperature. In an embodiment, the separation and/or absorption system is configured to control the process fluid temperature and/or pressure in order to facilitate forming carbon dioxide or other component as a solid. The separation and/or absorption system may also include one or more components for controlling the pressure and/or flow rate of process fluid through the separation and/or absorption system.

A “process fluid” may be a liquid or gas that includes a component to be separated. In an embodiment, the process fluid includes carbon dioxide liquid or gas, which is cooled such that carbon dioxide transitions to a solid phase (e.g., as solid carbon dioxide or a hydrate).

In an embodiment, the separation and/or absorption system includes a mixing unit or module, in which the process fluid is mixed with another fluid (thermal fluid or cooling fluid) to reduce the process fluid temperature prior to entering the heat exchanger or passageways therein. Each passageway may include a regenerative froth contactor (RFC) or other structure to improve heat transfer.

A phase separation system may be included downstream of the heat exchanger for separating solid phase components from the fluid mixture. Gaseous components of the fluid mixture may be fed back into the heat exchanger and/or the mixing module to further facilitate cooling and solid phase formation.

Embodiments described herein present a number of advantages. For example, the separation and/or absorption system is able to more quickly cool fluid, thereby enhancing the separation process, and simultaneously avoid plugging the flow passages. In addition, the separation and/or absorption system is compact and easily scalable, as compared to existing systems that are typically only in small scale.

Existing systems require a large surface area to cool down to target temperature. Embodiments described herein address this limitation by providing for cooling and solid formation using a smaller heat exchanger.

The separation and/or absorption system may be part of an offshore or onshore plant. For example, the separation and/or absorption system may be installed in offshore, ship cargoes and/or post combustion facilities to remove carbon dioxide.

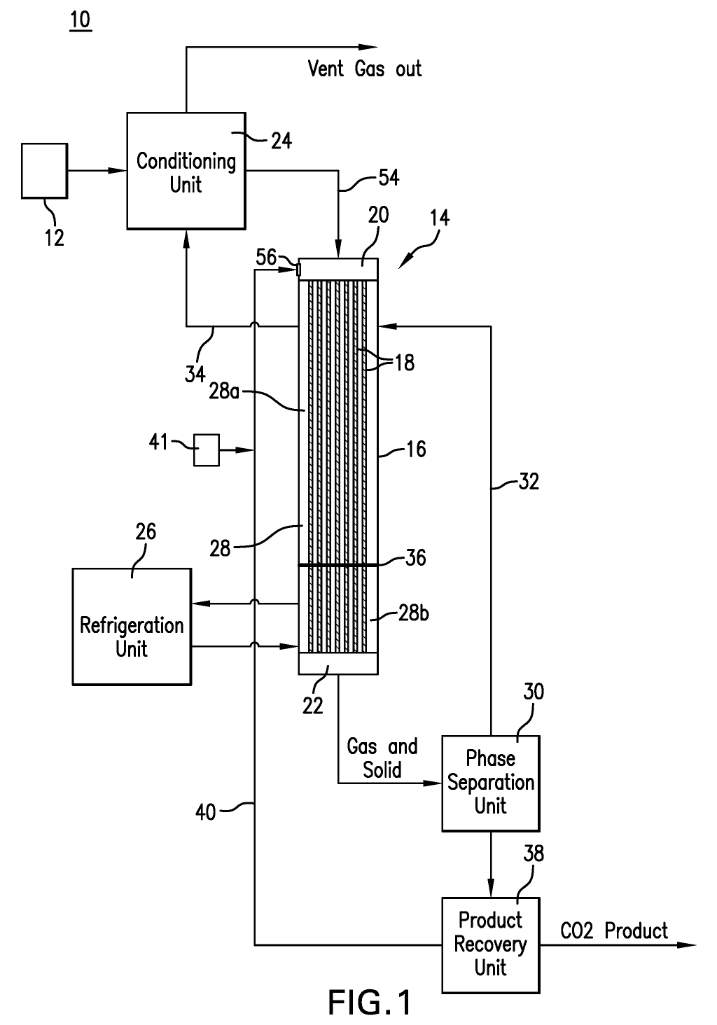

A simplified schematic diagram of a separation and/or absorption system 10 according to one or more embodiments is shown in FIG. 1. The separation and/or absorption system 10 is configured to absorb and separate a component from a process fluid. In an embodiment, the separation and/or absorption system 10 is configured as, or is a part of, a carbon dioxide capture system, although the present disclosure is not limited thereto.

The separation and/or absorption system 10 is configured to receive a process fluid from any suitable source. In an embodiment, the separation and/or absorption system 10 receives a gas and/or liquid, such as carbon dioxide, from a fluid source 12 at an initial temperature. The fluid source 12 may be a flue gas source, gases from a hydrocarbon production system, or other. For example, the fluid source 12 is a manufacturing or chemical system (e.g., an oil refinery) that produces a flue gas which may contain carbon dioxide. In another example, the fluid source 12 is gas extracted from a subterranean region (e.g., hydrocarbon bearing formation), or any other suitable fluid from which carbon dioxide or other gases is desired to be removed. In another example, the fluid source 12 is environmental or ambient air (e.g., the system 10 is a direct air capture (DAC) system.

Embodiments are described herein in conjunction with an input gas, such as flue gas. It is to be understood that the embodiments are applicable for use with any suitable fluid having a component desired to be absorbed and/or separated.

The system 10 further includes an absorption column assembly 14, also referred to as an absorption system 14 or heat exchanger. The absorption column assembly 14 defines one or more passageways through which the input gas is flowed. Within each passageway, absorption and/or separation processes occur that cause a component to be separated from the input gas.

The absorption system 14 includes a housing 16 configured as an absorption column that houses one or more absorption column modules 18. Each absorption column module 18 defines a passageway through which a process fluid is flowed for cooling, separation and/or absorption as described further herein.

In an embodiment, the absorption system 14 is configured as a shell-and-tube heat exchanger. In this embodiment, the absorption column modules 18 are thermally conductive tubes, and the housing 16 forms a shell surrounding the tubes.

The absorption system 14 may include an upstream mixing unit 20 in fluid communication with each absorption column module 18. A downstream collector structure 22 may be included, which is in fluid communication downstream of each absorption column module 18.

The separation and/or absorption system 10 includes one or more additional components for facilitating heat transfer and cryogenic capture of a component of a process fluid, such as carbon dioxide. In an embodiment, the separation and/or absorption system 10 includes a conditioning unit 24, which pre-conditions the input gas to adjust an initial operating condition of the input gas. For example, the conditioning unit 24 is configured to reduce a temperature of the input gas from the initial temperature to a lower temperature (“first temperature”). The conditioning unit 24 may be configured to cool the input gas, for example by exchanging energy with fluid from 34.

The mixing unit 20 receives the conditioned input gas from the conditioning unit 24, where the input gas is mixed to another fluid to further reduce the temperature from the first temperature to a lower temperature (“second temperature”). A result is a fluid mixture that is then injected into one or more absorption column modules 18.

The absorption system 14 may include a refrigeration unit 26 in fluid communication with an internal volume of the housing 16, referred to as a column space 28. The refrigeration unit 26 circulates a refrigerant or other fluid at a temperature sufficient to ensure that a phase change (e.g., phase change to have a hydrate or solid CO2) occurs. For example, as the fluid mixture flows through each absorption column module 18, the fluid mixture is further cooled to a temperature that is low enough to cause a component to solidify or otherwise be in a solid phase, creating a mixed-phase fluid.

The separation and/or absorption system may include one or more components for separating the solid phase from the mixed-phase fluid (e.g., liquid, vapor and CO2 solid or hydrate phase). The solid phase may then be stored as a solid, liquid or gas, and/or may be directed to any desired location or system. Gaseous components, such as water vapor, nitrogen and/or oxygen, may be redirected to enhance the heat transfer.

In an embodiment, the separation and/or absorption system 10 includes a phase separation unit 30 connected to the downstream collector structure 22. The phase separation unit 30 may direct gaseous components (referred to herein as “vent gas”) via a fluid line 32 into the column space 28 to facilitate cooling the fluid mixture.

In an embodiment, the vent gas is a lean gas, wherein the vent gas does not include any carbon dioxide (or other component desired to be separated), or at least any significant amount. Alternatively, a lean gas is a gas that has a concentration of the component that is less than a threshold amount.

The vent gas and/or refrigerant in the column space 28 may be used to improve the separation process. For example, the vent gas (or portion thereof) may be fed to the conditioning unit 24 for conditioning the input gas (e.g., flue gas). The vent gas may be fed directly by a fluid line (not shown), or a combination of vent gas and refrigerant may be fed from the column space 28 to the conditioning unit 24 via the fluid line 34.

In an embodiment, the column space 28 is divided into multiple regions to provide for successive temperature reduction stages. For example, a separator 36 divides the column space 28 into a first space 28a, where vent gas and/or other fluids are circulated to cool the fluid mixture. A second space 28b is provided for further reducing temperature and ensuring phase changes by circulating the refrigerant from the refrigeration unit 26.

After the mixed-phase fluid is separated, solid phase carbon dioxide (CO2), or other solid phase component, may be directed to a product recovery unit 38, where the solid phase CO2 is prepared for use, storage and/or transport. The product recovery unit 38 may process the solid phase to produce solid, liquid or gaseous product (e.g., CO2). As shown, any liquid or gaseous components may be fed back to the absorption system 14 via a fluid line 40. A fluid source 41 may be in fluid communication with the fluid line 40, for injecting water or other fluid.

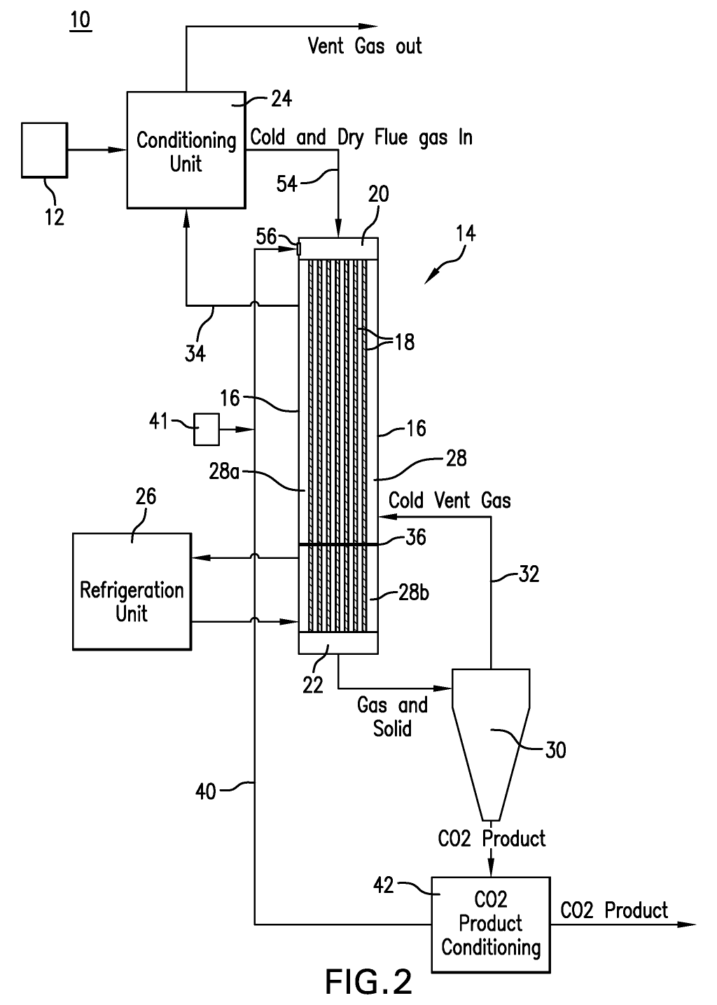

FIG. 2 shows an embodiment of the separation and/or absorption system 10, in which the phase separation unit 30 is a gravity-fed structure. The structure forms a conical or funnel shape, which allows solid phase to fall. Vent gas is removed and may be recirculated (e.g., fed into the column space 28 via the fluid line 32). The solid phase may be directed to a product conditioning unit 42, which outputs liquified CO2 or other fluid.

In use, the input gas is injected into the conditioning unit 24, where the pressure is adjusted to any desired pressure at the first temperature. Cold vent gas from the phase separation unit 30 may be fed into the conditioning unit 24 by a fluid line (not shown) to further lower the temperature.

The conditioned input gas then enters the mixing unit 20 via an input line 54, where the conditioned input gas is mixed with a low temperature cooling fluid. “Low temperature” refers to a temperature that is less than the first temperature of the conditioned input gas. For example, the conditioned input gas is mixed with a low temperature solvent (e.g., water, sea water, ethanol, an ethanol and water mixture, etc.) in the mixing unit 20, and the resulting fluid mixture is flowed through the absorption column modules 18.

As the fluid mixture flows through the absorption column modules 18, the refrigeration unit 26 circulates a refrigerant into a column space 28 (or just the column space 28b). Heat exchange between the refrigerant and the fluid mixture occurs as the fluid mixture flows through the column modules 18. In an embodiment, the fluid mixture flows through one or more regenerative froth contactors (RFCs) in each column module 18, where a phase change occurs due to a vapor-liquid-solid equilibrium (VLSE) condition.

At the bottom of the column modules 18, a mixed phase fluid is received at the downstream collector structure 22. Solid, treated gas vapor and liquid are separated. Cold treated gas may be flowed into the column space 28 and/or directed to other devices or systems. For example, at least some of the treated gas is flowed through an expander (not shown) to generate power to an inlet compressor, such as a compressor (not shown) connected to the conditioning unit 24.

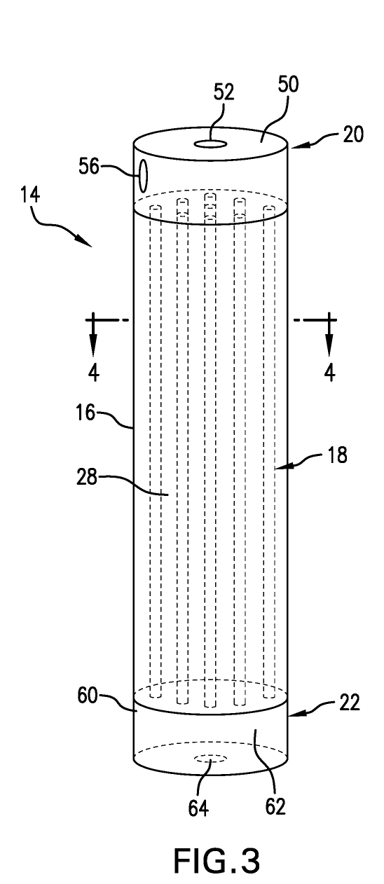

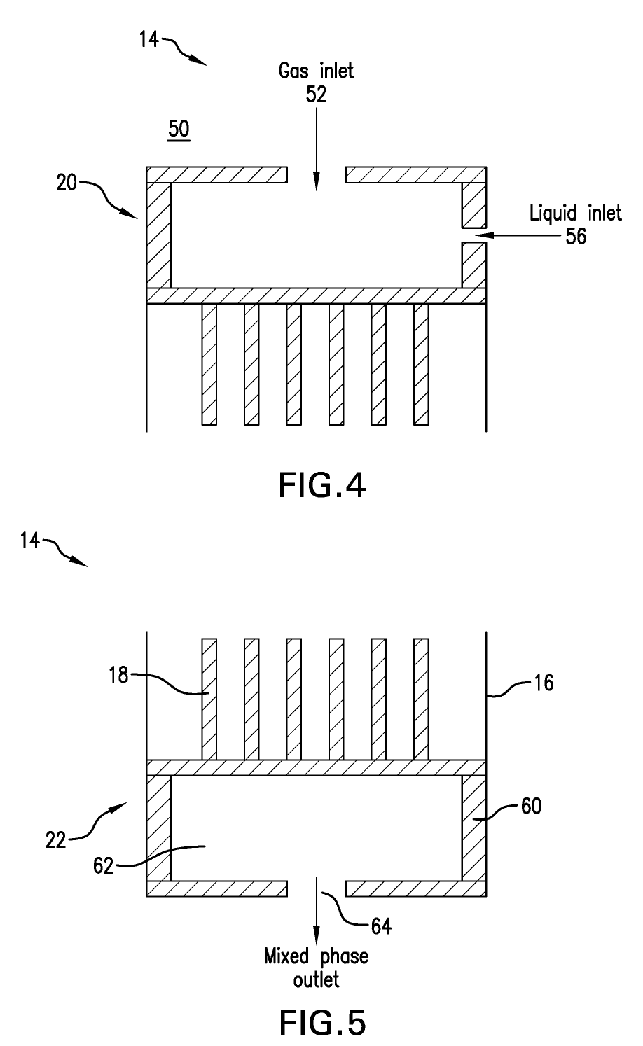

FIG. 3 shows an embodiment of the absorption system 14 including the mixing unit 20 and the downstream collector structure 22. FIGS. 4 and 5 show embodiments of the mixing unit 20 and the downstream collector structure 22, respectively.

As shown, the housing 16 forms an outer shell that defines the column space 28 therein. A plurality of absorption column modules 18 may be disposed within the outer shell, each of the absorption column modules 18 extending from the mixing unit 20 to the downstream collector structure 22. According to an embodiment, the absorption column modules 18 extend parallel to each other. The absorption column modules 18 may be spaced apart.

Referring to FIG. 4, the mixing unit 20 may include an upstream casing 50 that defines an upstream collector space therein. The upstream casing 50 may further define a gas inlet 52 for receiving flue gas or other process fluid. The gas inlet 52 may be fluidly coupled to a gas line 54 (FIGS. 1 and 2). The collector space is in fluid communication with the absorption column modules 18.

The mixing unit 20 also includes a fluid inlet 56 for receiving a gas, liquid or combined fluid (referred to as a “cooling fluid”). The cooling fluid and the inlet gas (e.g., a conditioned inlet gas) mix within the collector space, thereby cooling the inlet gas (i.e., initially cooling prior to additional cooling that occurs in the heat exchanger 14). The combination of the inlet gas and the cooling fluid is fed as a fluid mixture to the absorption column modules 18.

Referring to FIG. 5, the downstream collector structure 22 may include a downstream collector casing 60 that defines a downstream collector space 62 therein. The downstream collector casing 60 is in fluid communication with the absorption column modules 18 for receiving a mixed-phase fluid. The mixed phase fluid includes a solid phase (e.g., solid CO2, CO2 hydrate or other component in solid form), liquid phase and/or gaseous components such as vapor. A mixed-phase outlet 64 permits the mixed-phase fluid to be transmitted for further processing. For example, the mixed-phase outlet 64 is connected to the product recovery unit 38 (FIG. 1).

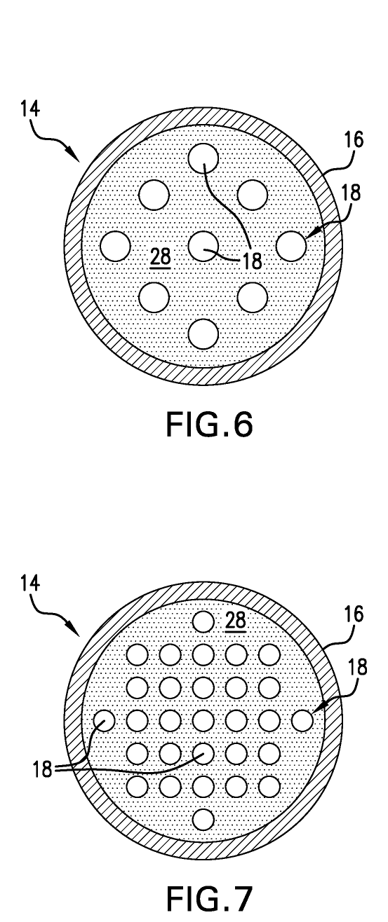

FIG. 6 shows an example of a cross-sectional view of the absorption system 14 of FIG. 3 taken at line “4-4”. In this example, there are nine absorption column modules 18; however, embodiments are not so limited, as there may be any number (i.e. one or more) of modules 18 having any suitable position. As a further example, FIG. 7 shows twenty-nine absorption column modules 18. Each of the absorption column modules 18 (or a subset thereof) may be sized identically. Alternatively, the absorption column modules 18 may be sized differently.

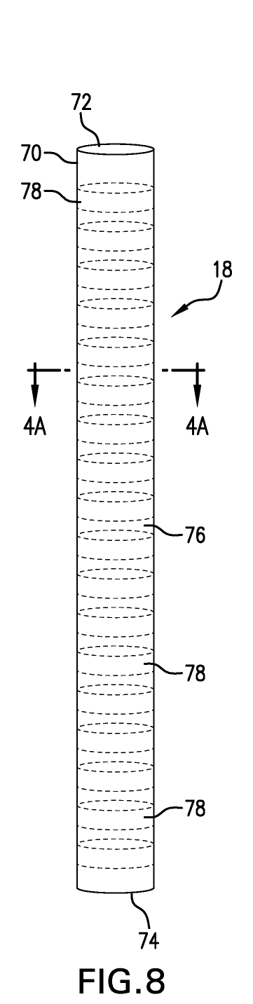

FIG. 8 shows an absorption column module 18 according to one or more embodiments. The absorption column module 18 may include a module casing 70 that defines the module inlet 72 at a first longitudinal end, a module outlet 74 at a second longitudinal end, and a module space 76 therebetween. The module casing 70 may be structured as a pipe or tube. The module casing 70 may be metallic, ceramic, polymeric, composite and/or any other thermally conductive material. The module casing 70 may be of any size and shape. For example, the module casing 70 has a diameter between 4 and 24 inches.

At least one contactor module 78 is disposed in the module space 76 and functions to facilitate heat transfer and solid phase formation. For example, as shown in FIG. 8, the module space 76 includes a plurality of contactor modules 78 arrayed vertically. Any number of contactor modules 78 may be included, being of any suitable type.

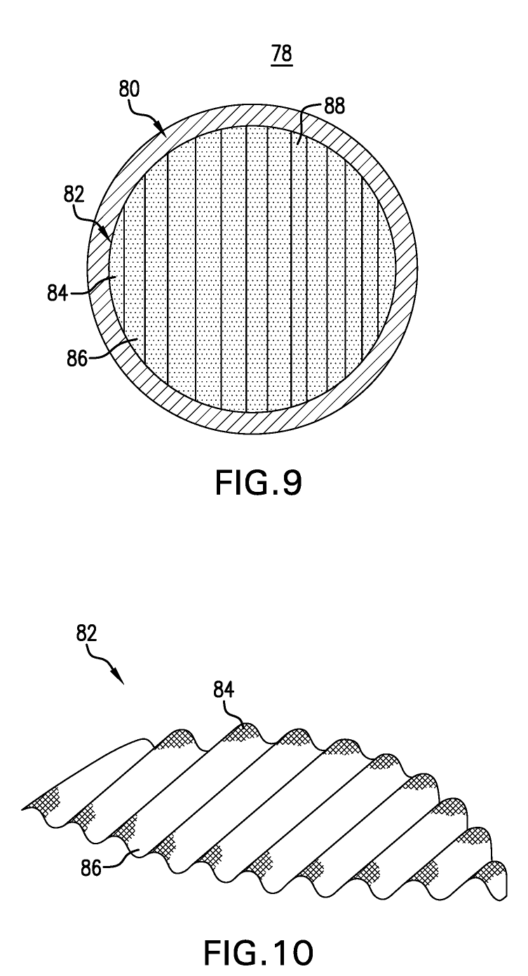

For example, referring to FIGS. 9 and 10, one or more of the contactor modules 78 is a corrugated screen packing module. FIG. 9 is a cross-sectional view of absorption column module 18 taken at a line “4A-4A”. In this example, the contactor module 78 includes a module casing 80 and may include a corrugated screen 82. The corrugated screen 82 may include ridges 84 and valleys 86 in an alternating arrangement. According to one or more embodiments, apertures 88 formed in the corrugated screen 82 are sized and arranged to maximize a pulsing effect while minimizing the packing material.

The corrugated screen packing modules may induce the absorption column module 18 to operate under a froth condition in two-phase or three-phase flow with millions of bubbles and droplets being formed in the absorption column module 18. The bubbles may be created as bands of froth collapse and are regenerated. The pulse flow may occur due to a hydrodynamic multi-phase phenomenon depending on the flow rates and the design of the corrugated screen packing modules. A fluid mixture may pass through multiple zones of froth along the corrugated screen packing modules.

According to one or more embodiments, the absorption column module 18 may be, or include, a regenerative froth contactor (RFC) equipped with the corrugated screens 82 having no moving parts. The RFC operates in a downward co-flow configuration. The corrugated screens 82 may be formed of convoluted screens that may increase a solvent pulsing effect-and may decrease metal packing material, relative to convention-by inducing the absorption column module 18 to operate under a transient froth condition in multi-phase flow. The pulse flow may be set up as a hydrodynamic multi-phase phenomenon, corresponding to a specific region in a flow map within the absorption column module 18.

Mass transfer may take place in pulses of froth formed by gas and liquid. As bands of froth propagate down the absorption column module 18, the absorber enables a high contact surface area and efficient mixing, with millions of bubbles and droplets created as bands of froth collapse and are regenerated. A desired component (e.g., CO2 in flue gas) may be allowed to cool and change phase, while the RFC modules 18 may govern the froth.

The applicable flow map may depend on characteristics of fluids and selected geometry of the contactor modules 78. For some gas/liquid systems, a geometry of the contactor modules 78 may be selected to enforce a preferred pulse area on the flow map and a coarser or thinner froth, through effects of the contactor modules 78 on the hydrodynamic regime.

According to one or more embodiments, arranging a plurality of absorption column modules 18 in the absorption system 14 allows for a common size of components to be used for different absorption systems 14. For example, for a larger absorption system 14, a number of the absorption column modules 18 may be increased. Furthermore, each of the absorption column modules 18 may operate independently of the others such that, even if one of the absorption column modules 18 operates at a lower efficiency, the other absorption column modules 18 may still operate efficiently.

Although an example of carbon dioxide is set forth with respect to a component to be removed from the flue gas and/or environmental gas (or other process fluid), the system 10 may also be applicable to other components, such as H₂S, SO₂, O₂, COS, etc. The absorption column assembly 14 may be applicable to any application that involves separation of a component from a process fluid.

Set forth below are some embodiments of the foregoing disclosure:
Embodiment 1: A system for separating and/or absorbing a component from a process fluid, comprising: a mixing module configured to receive the process fluid at a first temperature and combine the process fluid with a cooling fluid to produce a fluid mixture having a second temperature that is less than or equal to the first temperature, wherein the process fluid includes the component; a housing; a passageway disposed in the housing, the passageway configured to receive the fluid mixture; and a cooling module configured to inject a refrigerant into the housing to cool the fluid mixture to a third temperature and cause the component to change to a solid phase.
Embodiment 2: The system as in any prior embodiment, wherein the process fluid is a gas, and the component is carbon dioxide.
Embodiment 3: The system as in any prior embodiment, wherein the passageway includes an internal contactor module configured to facilitate heat and mass transfer between the fluid mixture and the refrigerant.
Embodiment 4: The system as in any prior embodiment, wherein the internal contactor module is a regenerative froth contactor (RFC).
Embodiment 5: The system as in any prior embodiment, further comprising a collector in fluid communication with the passageway, the collector configured to direct the solid phase and a separated fluid to a phase separation unit.
Embodiment 6: The system as in any prior embodiment, wherein the process fluid is carbon dioxide gas, and the solid phase is selected from at least one of solid carbon dioxide and a carbon dioxide hydrate.
Embodiment 7: The system as in any prior embodiment, further comprising a fluid line configured to direct a portion of the separated fluid from the phase separation unit to a conditioning unit, the conditioning unit configured to adjust an initial operating condition of the process fluid.
Embodiment 8: The system as in any prior embodiment, wherein the housing and the passageway are part of a shell-and-tube heat exchanger.
Embodiment 9: The system as in any prior embodiment, wherein the process fluid is an input gas, and the system includes a conditioning unit configured to receive the input gas, reduce an initial temperature of the input gas to the first temperature, and direct the input gas to the mixing module.
Embodiment 10: The system as in any prior embodiment, wherein the conditioning unit is configured to adjust an initial operating condition of the input gas.
Embodiment 11: A method of separating and/or absorbing a component from a process fluid, comprising: receiving the process fluid that includes the component, the process fluid having a first temperature; directing the process fluid to a mixing module and combining the process fluid with a cooling fluid to produce a fluid mixture having a second temperature that is less than or equal to the first temperature; flowing the fluid mixture into a passageway disposed in a housing of a heat exchanger; and circulating a refrigerant in a space between the housing and the passageway, the refrigerant causing the fluid mixture to cool to a third temperature and cause the component to change to a solid phase.
Embodiment 12: The method as in any prior embodiment, wherein the process fluid is a gas, and the component is carbon dioxide.
Embodiment 13: The method as in any prior embodiment, wherein the passageway includes an internal contactor module configured to facilitate heat and mass transfer between the fluid mixture and the refrigerant.
Embodiment 14: The method as in any prior embodiment, further comprising directing the process fluid to a conditioning unit, and controlling an initial operating condition of the process fluid prior to directing the process fluid to the mixing module.
Embodiment 15: The method as in any prior embodiment, wherein the internal contactor module is a regenerative froth contactor (RFC).
Embodiment 16: The method as in any prior embodiment, further comprising receiving the solid phase and the fluid mixture at a collector in fluid communication with outlet of the passageway.
Embodiment 17: The method as in any prior embodiment, wherein the process fluid is carbon dioxide gas, and the solid phase is selected from at least one of solid carbon dioxide and a carbon dioxide hydrate.
Embodiment 18: The method as in any prior embodiment, wherein the housing and the passageway are part of a shell-and-tube heat exchanger.
Embodiment 19: The method as in any prior embodiment, wherein the process fluid is an input gas, and the method further comprises flowing the process fluid to a conditioning unit, reducing an initial temperature of the input gas to the first temperature, and directing the input gas to the mixing module.
Embodiment 20: The method as in any prior embodiment, wherein the conditioning unit is configured to adjust an initial operating condition of the input gas.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ± 8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for separating and/or absorbing a component from a process fluid, comprising:
a mixing module configured to receive the process fluid at a first temperature and combine the process fluid with a cooling fluid to produce a fluid mixture having a second temperature that is less than or equal to the first temperature, wherein the process fluid includes the component;
a housing;
a passageway disposed in the housing, the passageway configured to receive the fluid mixture; and
a cooling module configured to inject a refrigerant into the housing to cool the fluid mixture to a third temperature and cause the component to change to a solid phase.

2. The system of claim 1, wherein the process fluid is a gas, and the component is carbon dioxide.

3. The system of claim 1, wherein the passageway includes an internal contactor module configured to facilitate heat and mass transfer between the fluid mixture and the refrigerant.

4. The system of claim 3, wherein the internal contactor module is a regenerative froth contactor (RFC).

5. The system of claim 1, further comprising a collector in fluid communication with the passageway, the collector configured to direct the solid phase and a separated fluid to a phase separation unit.

6. The system of claim 5, wherein the process fluid is carbon dioxide gas, and the solid phase is selected from at least one of solid carbon dioxide and a carbon dioxide hydrate.

7. The system of claim 5, further comprising a fluid line configured to direct a portion of the separated fluid from the phase separation unit to a conditioning unit, the conditioning unit configured to adjust an initial operating condition of the process fluid.

8. The system of claim 1, wherein the housing and the passageway are part of a shell-and-tube heat exchanger.

9. The system of claim 1, wherein the process fluid is an input gas, and the system includes a conditioning unit configured to receive the input gas, reduce an initial temperature of the input gas to the first temperature, and direct the input gas to the mixing module.

10. The system of claim 9, wherein the conditioning unit is configured to adjust an initial operating condition of the input gas.

11. A method of separating and/or absorbing a component from a process fluid, comprising:
receiving the process fluid that includes the component, the process fluid having a first temperature;
directing the process fluid to a mixing module and combining the process fluid with a cooling fluid to produce a fluid mixture having a second temperature that is less than or equal to the first temperature;
flowing the fluid mixture into a passageway disposed in a housing of a heat exchanger; and
circulating a refrigerant in a space between the housing and the passageway, the refrigerant causing the fluid mixture to cool to a third temperature and cause the component to change to a solid phase.

12. The method of claim 1, wherein the process fluid is a gas, and the component is carbon dioxide.

13. The method of claim 1, wherein the passageway includes an internal contactor module configured to facilitate heat and mass transfer between the fluid mixture and the refrigerant.

14. The method of claim 1, further comprising directing the process fluid to a conditioning unit, and controlling an initial operating condition of the process fluid prior to directing the process fluid to the mixing module.

15. The method of claim 13, wherein the internal contactor module is a regenerative froth contactor (RFC).

16. The method of claim 11, further comprising receiving the solid phase and the fluid mixture at a collector in fluid communication with outlet of the passageway.

17. The method of claim 16, wherein the process fluid is carbon dioxide gas, and the solid phase is selected from at least one of solid carbon dioxide and a carbon dioxide hydrate.

18. The method of claim 11, wherein the housing and the passageway are part of a shell-and-tube heat exchanger.

19. The method of claim 11, wherein the process fluid is an input gas, and the method further comprises flowing the process fluid to a conditioning unit, reducing an initial temperature of the input gas to the first temperature, and directing the input gas to the mixing module.

20. The method of claim 19, wherein the conditioning unit is configured to adjust an initial operating condition of the input gas.
